(19) United States
(12) Patent Application Publication
(10) Pub. No.: US 2006/0150796 A1
(43) Pub. Date: Jul. 13, 2006

(54) Multi-angular trimming apparatus

(76) Inventor: Tzu-Feng Tseng, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(21) Appl. No.: 11/070,820

(22) Filed: Mar. 2, 2005

(30) Foreign Application Priority Data
Jan. 7, 2005 (TW) 094100431

(51) Int. Cl. B26D 5/00

(52) U.S. Cl. 83/745; 83/565

(57) ABSTRACT

A multi-angular trimming apparatus includes a platform, a trimming track, a movable device and an angle-adjustable member. The trimming track includes a guiding slot to have a trimmer move therein to trim the sheet article. The movable device includes first and second movable members. The first movable member strides across two side edges of the platform to have the trimming track above the first movable member move in a first direction. The second movable member is disposed above the first movable member to have the trimming track move in a second direction. The angle-adjustable member is coupled to the second movable member and includes at least an angle-adjustable base having a plurality of retaining points, a connection member for securing the trimming track onto the angle-adjustable base and a retaining member positioning in one of the retaining points so as to have the trimmer perform multi-angular trimming operations.

### FIELD OF THE INVENTION

The present invention relates to a trimming apparatus, and more particularly to a trimming apparatus capable of performing multi-angular trimming operations.

### BACKGROUND OF THE INVENTION

Conventionally, the trimming apparatus for trimming sheet articles such as papers, photographs or the like commonly uses a trimming mechanism to perform the trimming operation. Generally, the trimming mechanism is fixed on a side of a trimming platform, and comprises a fixed trimming knife and a suppression device. Alternatively, the trimming mechanism comprises a glidable trimmer. In a case that the trimming mechanism is utilized to impart a certain angle, for example 30 or 45 degree, between the trimming knife and the sheet articles, the sheet articles should be firstly rotated to have a desired angle with respect to the trimming knife and then a trimming operation is done.

Since the certain angle is imparted by manually rotating the sheet articles, the trimming precision is usually insufficient. In addition, because only some specified angles between the trimming knife and the sheet articles are adjustable, the trimming mechanism of the prior art fails to provide multi-angular trimming operations and thus the application of the trimming apparatus is restricted.

### SUMMARY OF THE INVENTION

It is an object of the present invention to provide a trimming apparatus capable of performing multi-angular trimming operations without the need of rotating the sheet articles.

In accordance with a first aspect of the present invention, there is provided a multi-angular trimming apparatus for trimming a sheet article. The multi-angular trimming apparatus comprises a platform, a trimming track, a movable device and an angle-adjustable member. The platform is used for placing thereon the sheet article. The trimming track comprises a guiding slot to have a trimmer move therein to trim the sheet article. The movable device comprises first and second movable members. The first movable member strides across two side edges of the platform to have the trimming track above the first movable member move in a first direction. The second movable member is disposed above the first movable member to have the trimming track move in a second direction. The angle-adjustable member is coupled to the second movable member and comprises at least an angle-adjustable base having a plurality of retaining points, a connection member for securing the trimming track onto the angle-adjustable base and a retaining member positioning in one of the retaining points so as to have the trimmer perform multi-angular trimming operations.

In an embodiment, the first movable member comprises two fixed guiding tracks and a movable pole, the two fixed guiding tracks are disposed at opposite sides of the platform, respectively, and the movable pole movably strides across the two fixed guiding tracks.

In an embodiment, the second direction is perpendicular to the first direction.

In an embodiment, the second movable member is a gliding block movably striding across the first movable member.

In an embodiment, the multi-angular trimming apparatus further comprises a connection plate having two pivot shafts, wherein one of the pivot shafts is pivotally coupled to a side edge of the gliding block and the other one of the pivot shafts is pivotally coupled to a side edge of the angle-adjustable base such that the angle-adjustable base is suspendedly disposed at the side edge of the gliding block.

In an embodiment, the connection member comprises a screw, a bolt hole arranged in the angle-adjustable base and a bolt hole pedestal arranged at a side edge of the trimming track, wherein the screw penetrates through the bolt hole and is secured to the bolt hole pedestal so as to joint the side edge of the trimming track together with the angle-adjustable base.

In an embodiment, the plurality of retaining points comprises first and second retaining holes discretely arranged on the angle-adjustable base at 90 degrees with respect to the bolt hole. In another embodiment, the plurality of retaining points comprises first, second and third retaining holes, the first and second retaining holes being discretely arranged on the angle-adjustable base at 45 degrees with respect to the bolt hole, and the second and third retaining holes being discretely arranged on the angle-adjustable base at 45 degrees with respect to the bolt hole.

In an embodiment, the retaining member comprises a retaining pin having a ring-shaped trench structure, a resilience element and a snap ring. The retaining pin penetrates through a perforation on a side edge of the trimming track and is detachably positioned in one of the retaining points. The periphery of the retaining pin is sheathed with the resilience element. The snap ring is fixed in the ring-shaped trench structure such that the resilience element is sustained and restrained between the snap ring and the trimming track.

In an embodiment, the retaining member comprises a nut, a screw and an E-shaped ring. The screw and the E-shaped ring are disposed under the angle-adjustable base, and the screw successively penetrates through the E-shaped ring and one of the first and second retaining holes and is fastened onto a side edge of the trimming track together with the nut.

In accordance with a second aspect of the present invention, there is provided a multi-angular trimming apparatus for trimming a sheet article. The multi-angular trimming apparatus comprises a platform, a trimming track, a first movable member and an angle-adjustable device. The platform is used for placing thereon the sheet article. The trimming track comprises a guiding slot to have a trimmer move therein to trim the sheet article. The first movable member strides across two side edges of the platform to have the trimming track above the first movable member move in a first direction. The angle-adjustable device movably strides across the first movable member and moves in a second direction. The angle-adjustable device comprises at least an angle-adjustable base disposed at a side of the first movable member and has a plurality of retaining points, a connection member for securing the trimming track onto the angle-adjustable base and a retaining member positioning in one of the retaining points so as to have the trimmer perform multi-angular trimming operations.

In accordance with a third aspect of the present invention, there is provided a multi-angular trimming apparatus for trimming a sheet article. The multi-angular trimming apparatus comprises a platform, a trimming track, a first movable member and an angle-adjustable device. The platform is used for placing thereon the sheet article. The trimming track comprises a guiding slot to have a trimmer move therein to trim the sheet article. The first movable member strides across two side edges of the platform to have the trimming track above the first movable member move in a first direction. The second movable member is disposed above the first movable member to have the trimming track move in a second direction. The angle-adjustable member is coupled to the second movable member and comprises at least an angle-adjustable base having a plurality of retaining points, a connection member for securing the trimming track onto the angle-adjustable base and a retaining member positioning in one of the retaining points so as to have the trimmer perform multi-angular trimming operations.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1(A) is an assembling diagram of a multi-angular trimming apparatus according a preferred embodiment of the present invention wherein the trimming track thereof is placed in a horizontal direction;

FIG. 1(B) is an assembling diagram of a multi-angular trimming apparatus according a preferred embodiment of the present invention wherein the trimming track thereof is placed in a vertical direction;

FIGS. 2(A) and 2(B) schematically illustrate the relative locations of a retaining member and the trimming track for a purpose of adjusting different trimming angles;

FIGS. 3(A) and 3(B) schematically illustrate the relative locations of another retaining member and the trimming track for a purpose of adjusting different trimming angles;

FIG. 4 is an exemplified angle-adjustable base having two retaining holes; and

FIG. 5 is another exemplified angle-adjustable base having three retaining holes.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

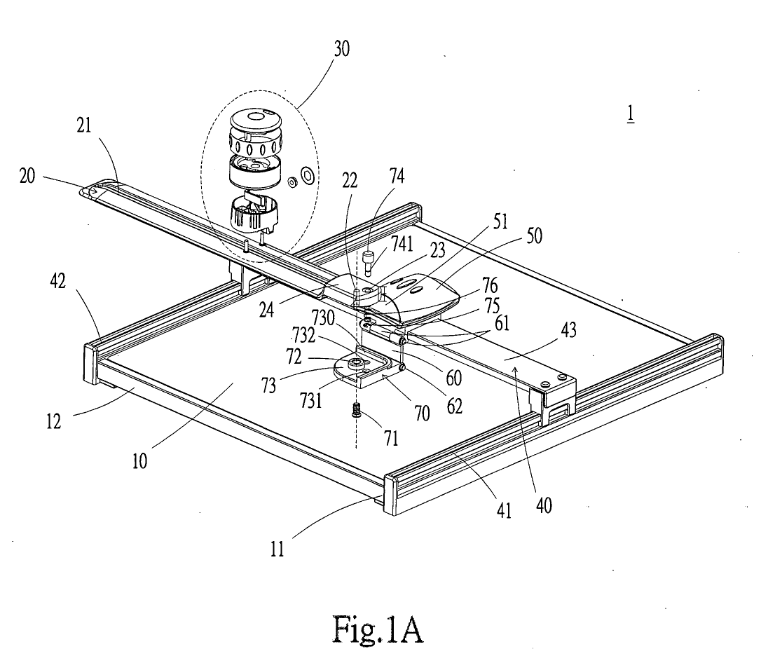

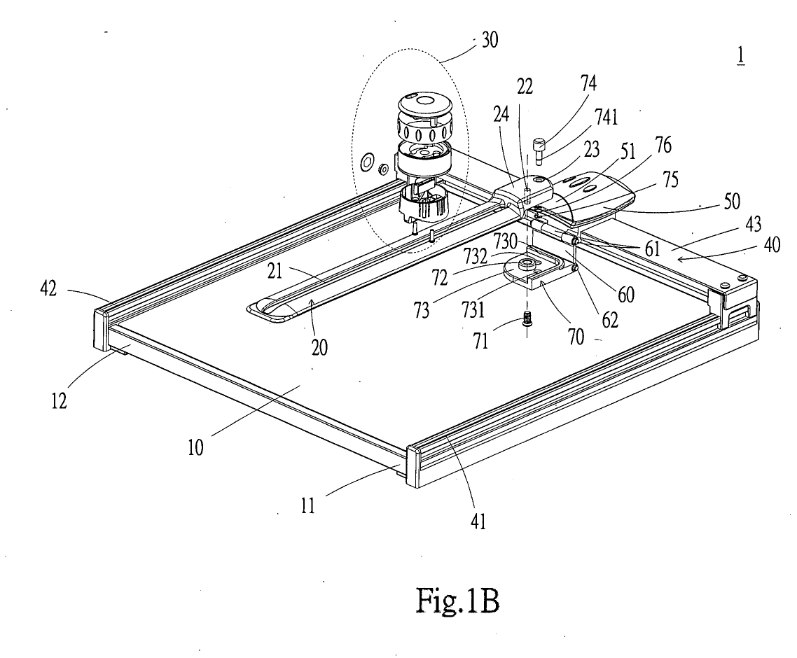

Please refer to FIGS. 1(A) and 1(B), which are assembling diagrams of a multi-angular trimming apparatus according a preferred embodiment of the present invention wherein the trimming tracks thereof are placed in horizontal and vertical directions, respectively.

In FIG. 1(A), the multi-angular trimming apparatus 1 of the present invention comprises a platform 10 for placing thereon the sheet articles such as papers or photographs (not shown), a trimming track 20 comprising a guiding slot 21, a trimmer 30, a first movable member 40, a second movable member 50, a connection plate 60 having two pivot shafts and an angle-adjustable member 70. The trimmer 30 moves along the guiding slot 21 so as to trim the sheet articles. The first movable member 40 comprises two fixed guiding tracks 41 and 42 and a movable pole 43. These two fixed guiding tracks 41 and 42 are disposed at opposite side edges 11 and 12 of the platform 10, respectively. The movable pole 43 movably strides across the two fixed guiding tracks 41 and 42 and can move in a first direction. The first movable member 40 in this embodiment comprises these two fixed guiding tracks 41 and 42 and the movable pole 43. It is noted that, however, those skilled in the art will readily observe that numerous modifications and alterations of the first movable member 40 may be made while retaining the teachings of the invention. For example, each of these two fixed guiding tracks 41 and 42 can be provided with a hollow guiding slot, and the movable pole 43 further has a protruding edge to be embedded into the hollow guiding slots. Accordingly, the above disclosure should be limited only by the bounds of the following claims.

Preferably, the second movable member 50 is a gliding block, movably strides across the movable pole 43 and moves in a second direction. Instead, other means equivalent to the gliding block 50 can be supported by the movable pole 43 and moves in the second direction. In the above embodiments, the first direction is perpendicular to the second direction.

By means of the movable device consisting of the first movable member 40 and the second movable member 50, the trimmer 30 can reach anywhere of the platform 10 to perform the trimming operations.

The angle-adjustable member 70 is coupled to the gliding block 50 via the connection plate 60 and suspendedly disposed at a side edge 51 of the gliding block 50. The angle-adjustable member 70 comprises at least an angle-adjustable base 73 having a plurality of retaining points such as a first retaining hole 731 and a second retaining hole 732 shown in FIG. 1(A) or 1(B), a connection member to be connected with the trimming track 20 and a retaining member positioning in one of the retaining points. In a preferred embodiment, the connection member comprises a screw 71, a bolt hole 72 arranged in the angle-adjustable base 73 and a bolt hole pedestal 22 arranged at a side edge 24 of the trimming track 20. The screw 71 penetrates through the bolt hole 72 and is secured to the bolt hole pedestal 22 so as to joint the side edge 24 of the trimming track 20 together with the angle-adjustable base 73. It is noted that, however, those skilled in the art will readily observe that numerous modifications and alterations of the connection member may be made while retaining the teachings of the invention. For example, the connection member can optionally have a fixed pivot shaft. Accordingly, the above disclosure should be limited only by the bounds of the following claims.

For a purpose of connecting the angle-adjustable base 73 with the gliding block 50, in a preferred embodiment of the present invention, the angle-adjustable base 73 is connected to and suspendedly disposed at a side edge 51 of the gliding block 50 via the connection plate 60 having two pivot shafts 61 and 62. The pivot shaft 61 is pivotally coupled to the side edge 51 of the gliding block 50. Whereas, the other pivot shaft 62 is pivotally coupled to a side edge 730 of the angle-adjustable base 73. Alternatively, the gliding block 50, the connection plate 60 and the angle-adjustable member 70 are integrally formed into an angle-adjustable device so as to movably stride across the movable pole 43 and move in the second direction.

The multi-angular trimming apparatus 1 of the present invention is further characterized by having the retaining member of the angle-adjustable member 70. In a preferred embodiment, the retaining member comprises a retaining pin 74 having a ring-shaped trench structure 741, a resilience element 76 such as a spring and a snap ring 75. The retaining pin 74 penetrates through a perforation 23 on the side edge 24 of the trimming track 20 and is detachably positioned in one of the first retaining hole 731 and the second retaining hole 732. The periphery of the retaining pin 74 is sheathed with the resilience element 76. The snap ring 75 is fixed in the ring-shaped trench structure 741 such that the resilience element 76 is sustained and restrained between the snap ring 75 and the side edge 24 of the trimming track 20.

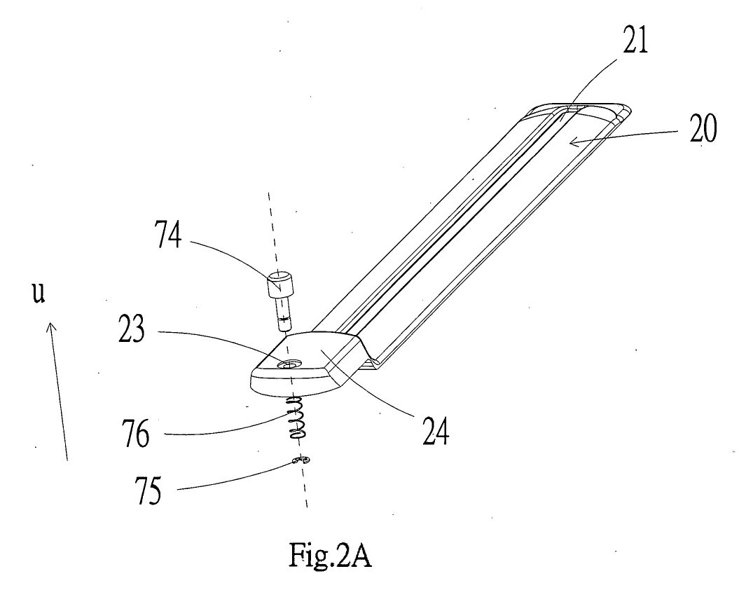

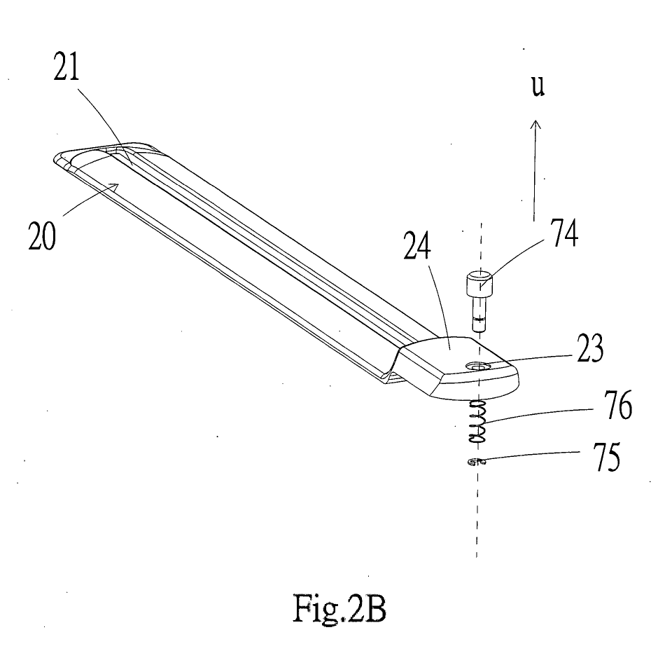

For a purpose of adjusting the trimming angle, the screw 71 should be firstly loosened such that the side edge 24 of the trimming track 20 can be pivoted about the angle-adjustable base 73 with the screw 71 serving as the pivot shaft. Subsequently, the retaining pin 74 is pulled up in the direction U, as shown in FIG. 2(A) or 2(B). Meanwhile, the resilience element 76 is compressed by means of the snap ring 75, and the retaining pin 74 can be detached from one of the first retaining hole 731 and the second retaining hole 732 and then positioned in the other one, thereby changing the trimming angle of the trimming track 20. For example, in a case that the retaining pin 74 is originally positioned in the first retaining hole 731 as shown in FIG. 1(A), for a purpose of changing the trimming angle, the retaining pin 74 should be firstly loosened and then the trimming track 20 is rotated in an anticlockwise direction such that the retaining pin 74 is also rotated in an anticlockwise direction above the top surface of the angle-adjustable base 73. After the retaining pin 74 is rotated to the region above the second retaining hole 732, by means of the recovery force resulted from the compressed resilience element 76, the retaining pin 74 will be pushed forward and inserted into the second retaining hole 732. In such manner, as shown in FIG. 1(B), the trimming angle is changed accordingly.

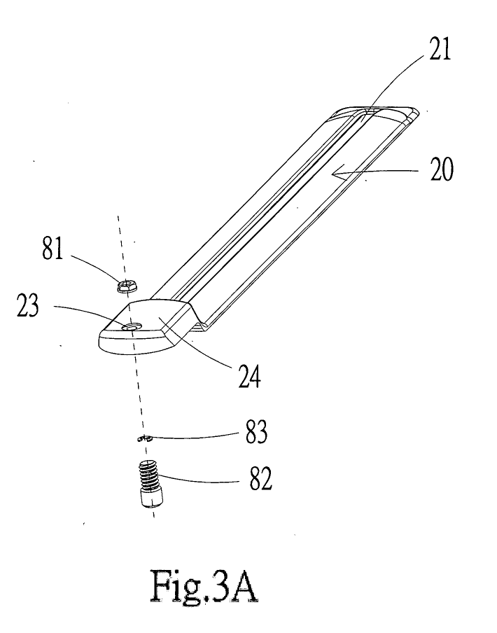

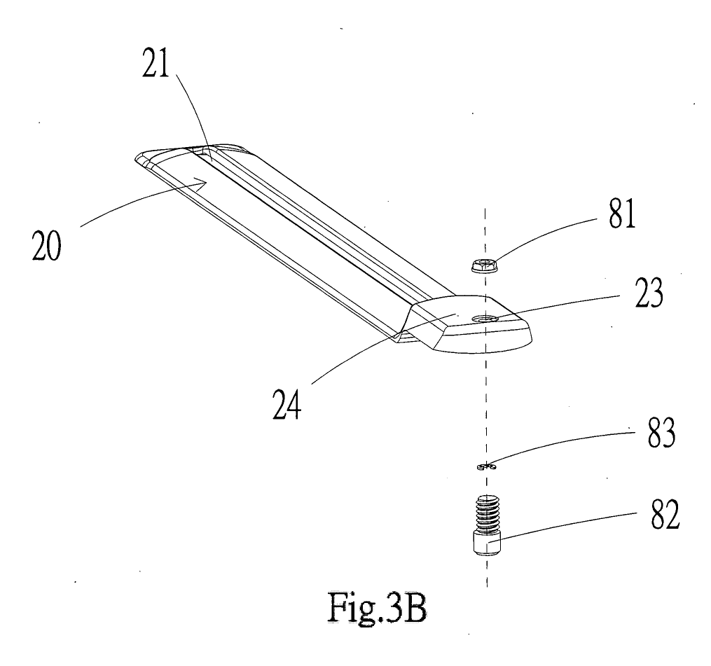

A further embodiment of a retaining member is illustrated in FIGS. 3(A) and 3(B). In FIG. 3(A), the retaining member comprises a nut 81, a screw 82 and an E-shaped ring 83. Please also refer to FIGS. 1(A) and 1(B). In this circumstance, the screw 82 and the E-shaped ring 83 are disposed under the angle-adjustable base 73. For a purposed of positioning the retaining member in the first retaining hole 731, as shown in FIG. 3(A) and referred to FIG. 1(A), the screw 82 should successively penetrate through the E-shaped ring 83, the first retaining hole 731 and the perforation 23, and then the screw 82 is fastened onto the side edge 24 of the trimming track 20 together with the nut 81. On the other hand, in order to change the trimming angle, the retaining member should be firstly dismantled and then the trimming track 20 is rotated in the anticlockwise direction such that the perforation 23 is aligned with the second retaining hole 732 as shown in FIG. 3(B) and referred to FIG. 1(B). After the screw 82 successively penetrates through the E-shaped ring 83, the second retaining hole 732 and the perforation 23, and is then fastened onto the side edge 24 of the trimming track 20 together with the nut 81, the retaining member will be positioned in the second retaining hole 732 so as to achieve the object of changing the trimming angle.

It is noted that, however, those skilled in the art will readily observe that numerous modifications and alterations of the retaining member and the connecting relationship between the angle-adjustable base and the connection member may be made while retaining the teachings of the invention. Accordingly, the above disclosure should be limited only by the bounds of the following claims.

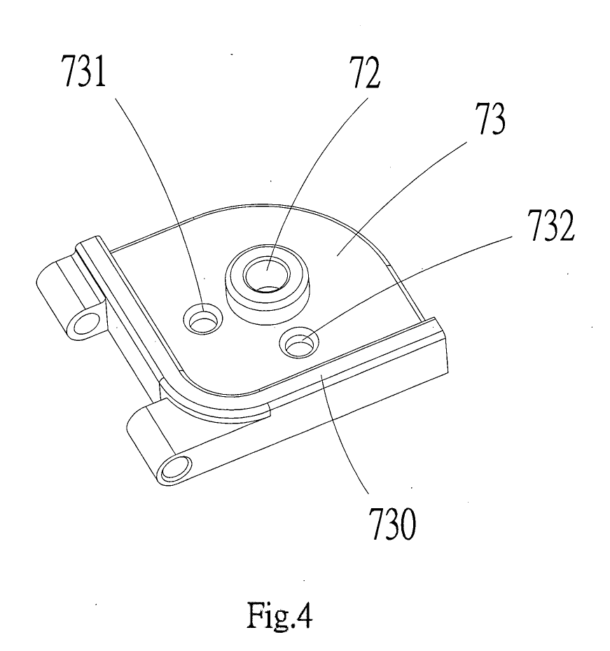

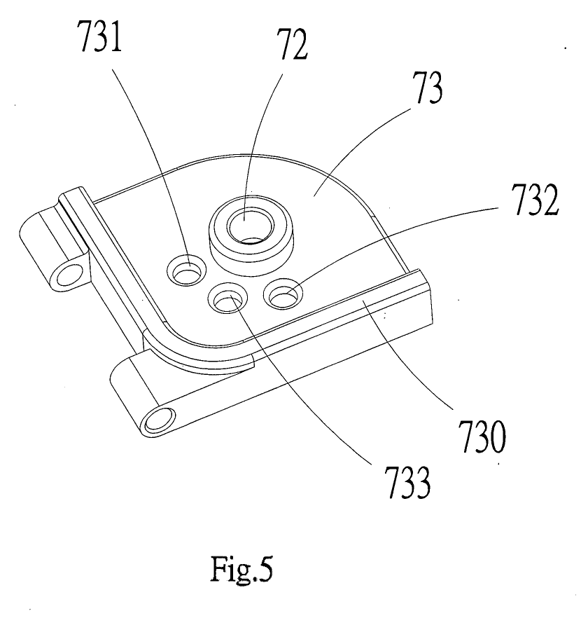

By the way, the number and the relative locations of the retaining holes of the angle-adjustable base 73 are relevant to the adjustable stages of the trimming angles. In FIG. 4, there are two retaining holes 731 and 732 in the angle-adjustable base 73, and these two retaining holes are discretely arranged on the angle-adjustable base at 90 degrees with respect to the bolt hole 72. In such manner, the multi-angular trimming apparatus can provide two-stage trimming angle adjustment. On the other hand, as the number of the retaining hole is increased, more stage of trimming angle adjustment is obtained. As shown in FIG. 5, there are three retaining holes 731, 732 and 733 in the angle-adjustable base 73. The retaining holes 731 and 733 are discretely arranged on the angle-adjustable base 73 at 45 degrees with respect to the bolt hole 72. Likewise, the retaining holes 732 and 733 are discretely arranged on the angle-adjustable base 73 at 45 degrees with respect to the bolt hole 72. In such manner, the multi-angular trimming apparatus can provide three-stage trimming angle adjustment.

It is understood from the above description, the trimming apparatus is capable of performing multi-angular trimming operations without the need of rotating the sheet articles.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A multi-angular trimming apparatus for trimming a sheet article, comprising: a platform for placing thereon said sheet article;
a trimming track comprising a guiding slot to have a trimmer move therein to trim said sheet article;
a movable device comprising first and second movable members, said first movable member striding across two side edges of said platform to have said trimming track above said first movable member move in a first direction, and said second movable member being disposed above said first movable member to have said trimming track move in a second direction; and
an angle-adjustable member coupled to said second movable member and comprising at least an angle-adjustable base having a plurality of retaining points, a connection member for securing said trimming track onto said angle-adjustable base and a retaining member positioning in one of said retaining points so as to have said trimmer perform multi-angular trimming operations.

2. The multi-angular trimming apparatus according to claim 1 wherein said first movable member comprises two fixed guiding tracks and a movable pole, said two fixed guiding tracks are disposed at opposite sides of said platform, respectively, and said movable pole movably strides across said two fixed guiding tracks.

3. The multi-angular trimming apparatus according to claim 1 wherein said second direction is perpendicular to said first direction.

4. The multi-angular trimming apparatus according to claim 1 wherein said second movable member is a gliding block movably striding across said first movable member.

5. The multi-angular trimming apparatus according to claim 4 further comprising a connection plate having two pivot shafts, one of said pivot shafts being pivotally coupled to a side edge of said gliding block and the other one of said pivot shafts being pivotally coupled to a side edge of said angle-adjustable base such that said angle-adjustable base is suspendedly disposed at said side edge of said gliding block.

6. The multi-angular trimming apparatus according to claim 1 wherein said connection member comprises a screw, a bolt hole arranged in the angle-adjustable base and a bolt hole pedestal arranged at a side edge of said trimming track, wherein said screw penetrates through said bolt hole and is secured to said bolt hole pedestal so as to joint said side edge of said trimming track together with said angle-adjustable base.

7. The multi-angular trimming apparatus according to claim 6 wherein said plurality of retaining points comprises first and second retaining holes discretely arranged on said angle-adjustable base at 90 degrees with respect to said bolt hole.

8. The multi-angular trimming apparatus according to claim 6 wherein said plurality of retaining points comprises first, second and third retaining holes, said first and second retaining holes being discretely arranged on said angle-adjustable base at 45 degrees with respect to said bolt hole, and said second and third retaining holes being discretely arranged on said angle-adjustable base at 45 degrees with respect to said bolt hole.

9. The multi-angular trimming apparatus according to claim 1 wherein said retaining member comprises a retaining pin having a ring-shaped trench structure, a resilience element and a snap ring, wherein said retaining pin penetrates through a perforation on a side edge of said trimming track and is detachably positioned in one of said retaining points, the periphery of said retaining pin is sheathed with said resilience element, and said snap ring is fixed in said ring-shaped trench structure such that said resilience element is sustained and restrained between said snap ring and said trimming track.

10. The multi-angular trimming apparatus according to claim 1 wherein said retaining member comprises a nut, a screw and an E-shaped ring, wherein said screw and said E-shaped ring are disposed under said angle-adjustable base, and said screw successively penetrates through said E-shaped ring and one of said first and second retaining holes and is fastened onto a side edge of said trimming track together with said nut.

11. A multi-angular trimming apparatus for trimming a sheet article, comprising:
a platform for placing thereon said sheet article;
a trimming track comprising a guiding slot to have a trimmer move therein to trim said sheet article;
a first movable member striding across two side edges of said platform to have said trimming track above said first movable member move in a first direction; and
an angle-adjustable device movably striding across said first movable member and moving in a second direction, wherein said angle-adjustable device comprises at least an angle-adjustable base disposed at a side of said first movable member and having a plurality of retaining points, a connection member for securing said trimming track onto said angle-adjustable base and a retaining member positioning in one of said retaining points so as to have said trimmer perform multi-angular trimming operations.

12. The multi-angular trimming apparatus according to claim 11 wherein said angle-adjustable device further comprises a second movable member, which is a gliding block movably striding across said first movable member.

13. A multi-angular trimming apparatus for trimming a sheet article, comprising:
a platform for placing thereon said sheet article;
a trimming track comprising a guiding slot to have a trimmer move therein to trim said sheet article;
a first movable member striding across two side edges of said platform to have said trimming track above said first movable member move in a first direction;
a second movable member disposed above said first movable member to have said trimming track move in a second direction; and
an angle-adjustable member coupled to said second movable member and comprising at least an angle-adjustable base having a plurality of retaining points, a connection member for securing said trimming track onto said angle-adjustable base and a retaining member positioning in one of said retaining points so as to have said trimmer perform multi-angular trimming operations.
